(19) United States
(12) Patent Application Publication
(10) Pub. No.: US 2014/0372611 A1
(43) Pub. Date: Dec. 18, 2014

(54) ASSIGNING METHOD, APPARATUS, AND SYSTEM

(71) Applicant: FUJITSU LIMITED, Kawasaki-shi (JP)

(72) Inventors: Yuichi Matsuda, Yokohama (JP); Haruyasu Ueda, Ichikawa (JP)

(73) Assignee: FUJITSU LIMITED, Kawasaki-shi (JP)

(21) Appl. No.: 14/256,394

(22) Filed: Apr. 18, 2014

(30) Foreign Application Priority Data
Jun. 14, 2013 (JP) 2013-126121

(51) Int. Cl. H04L 12/721; H04L 29/08

(52) U.S. Cl. CPC H04L 45/12; H04L 67/10
USPC 709/225

(57) ABSTRACT

An assigning method includes: identifying a distance between one or more first nodes to which first processing is assigned and one or more second nodes to which second processing to be performed on a processing result of the first processing is assignable, the first and second nodes being included in a plurality of nodes that are capable of performing communication; and determining a third node to which the second processing is to be assigned, based on the distance identified by the identifying, the third node being included in the one or more second nodes.

### CROSS-REFERENCE TO RELATED APPLICATION

This application is based upon and claims the benefit of priority of the prior Japanese Patent Application No. 2013-126121, filed on Jun. 14, 2013, the entire contents of which are incorporated herein by reference.

### FIELD

The embodiment discussed herein is related to an assigning method, an apparatus with respect to the assigning method, and a system.

### BACKGROUND

In recent years, as technology for processing an enormous amount of data, a distributed processing technology called MapReduce processing has been available. MapReduce is processing in which data processing is performed in two separate phases, namely, Map processing and Reduce processing using processing results of the Map processing. In MapReduce, a plurality of nodes execute Map processing on data resulting from division of stored data. With respect to the processing results of the Map processing, any of the plurality of nodes executes Reduce processing for obtaining processing results of the entire data.

For example, there is a technology in which various arrangement patterns for distributing Map processing and Reduce processing to a plurality of virtual machines are detected and an arrangement pattern at which cost considering an execution time, power consumption, and the amount of input/output (I/O) for each arrangement pattern is minimized is selected based on a result of calculation of the cost. There is also a technology in which groups of slave nodes each being directly coupled with corresponding switches are determined based on connection relationships between the slave nodes and the switches and data blocks to be processed in a distributed manner are deployed to one of the determined groups.

Examples of related technologies include Japanese Laid-open Patent Publication No. 2010-218307 and Japanese Laid-open Patent Publication No. 2010-244469.

### SUMMARY

According to an aspect of the invention, an assigning method includes: identifying a distance between one or more first nodes to which first processing is assigned and one or more second nodes to which second processing to be performed on a processing result of the first processing is assignable, the first and second nodes being included in a plurality of nodes that are capable of performing communication; and determining a third node to which the second processing is to be assigned, based on the distance identified by the identifying, the third node being included in the one or more second nodes.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an operation of an assigning apparatus according to an embodiment;

FIG. 2 illustrates an example of the system configuration of a distributed processing system;

FIG. 3 is a block diagram illustrating an example of the hardware configuration of a master node;

FIG. 4 illustrates an example of the software configuration of the distributed processing system;

FIG. 5 is a block diagram illustrating an example of the functional configuration of the master node;

FIG. 6 illustrates an example of MapReduce processing performed by the distributed processing system according to the present embodiment;

FIG. 7 is a block diagram of a distance function;

FIG. 8 illustrates an example of the contents of a distance function table;

FIG. 9 illustrates an example of setting distance coefficients;

FIG. 10 illustrates an example of the contents of a distance coefficient table;

FIG. 11 illustrates a first example of determining a node to which a Reduce task is to be assigned;

FIG. 12 illustrates a second example of determining a node to which a Reduce task is to be assigned;

FIG. 13 is a flowchart illustrating an example of a procedure for the MapReduce processing; and

FIG. 14 is a flowchart illustrating an example of a procedure of Reduce-task assignment node determination processing.

### DESCRIPTION OF EMBODIMENTS

According to the related technologies, as the distance between the node to which the Map processing is assigned and the node to which the Reduce processing is assigned increases, the amount of time taken to transfer processing results of the Map processing increases, thus increasing the amount of time taken for distribution processing.

An assigning method, an assigning apparatus, and a system according to an embodiment of the present disclosure will be described below in detail with reference to the accompanying drawings.

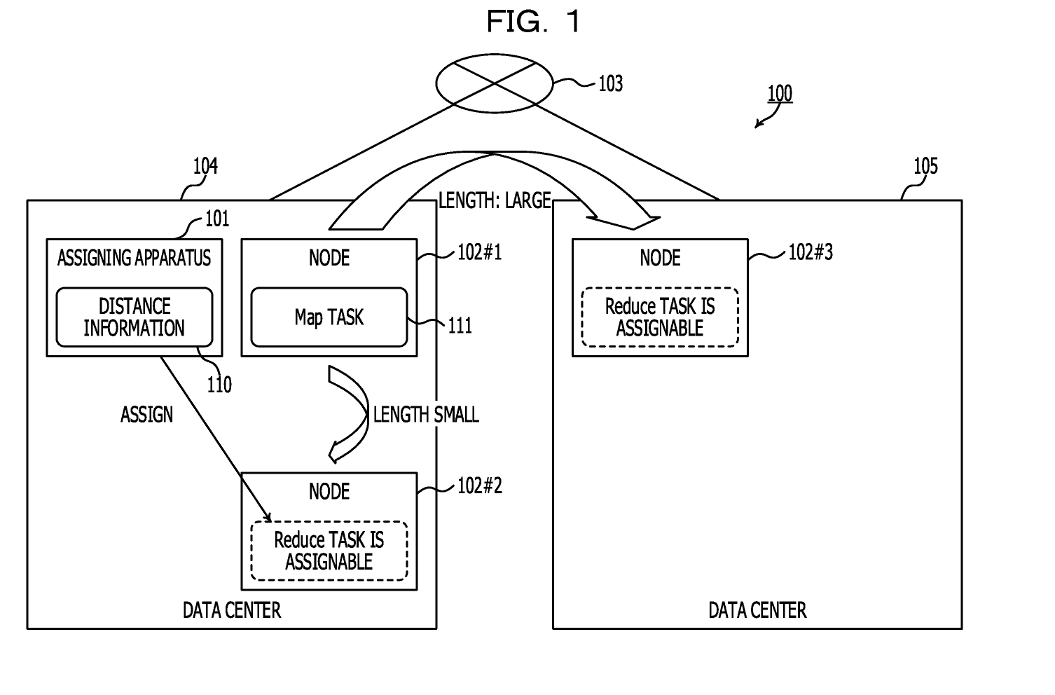

FIG. 1 illustrates an example of an operation of an assigning apparatus according to the present embodiment. A system 100 includes an assigning apparatus 101 that assigns first processing and second processing and a group of nodes 102 that are capable of communicating with the assigning apparatus 101. In the example illustrated in FIG. 1, the node group 102 in the system 100 includes a node 102#1, a node 102#2, and a node 102#3. The assigning apparatus 101 and the nodes 102#1 to 102#3 are coupled to each other through a network 103. Each node in the node group 102 is an apparatus that executes the first processing and the second processing assigned by the assigning apparatus 101. The assigning apparatus 101 and the nodes 102#1 and 102#2 are included in a data center 104, and the node 102#3 is included in a data center 105.

The term “data centers” as used herein refer to facilities where a plurality of resources, such as an apparatus for performing information processing and communication and a switch apparatus for relaying communications are placed. The data centers 104 and 105 are assumed to be located at a distance. The switch apparatus may hereinafter be referred to as a “switch”.

In the following description, a sign given a suffix “#x” with x being an index refers to the xth node 102. Also, when the expression “node 102” is used, a description thereof is common to all of the nodes 102.

First processing of one node 102 is independent from first processing assigned to another node 102, and all of the first processing assigned to the individual nodes 102 may be executed in parallel. For example, first processing is processing in which input data to be processed is used and data is output in accordance with the KeyValue format, independently from other first processing to be performed on other input data. The data having the KeyValue format is a pair of an arbitrary value contained in a value field and desired to be stored and a unique indicator corresponding to data contained in a key field and desired to be stored.

The second processing is processing to be performed on processing results of the first processing. For example, when processing results of the first processing are data having the KeyValue format, the second processing is processing to be performed on one or more processing results obtained by aggregating the processing results of the first processing, based on the key fields indicating attributes of the processing results of the first processing. For example, the second processing may be processing to be performed on one or more processing results obtained by aggregating the results of the first processing based on the value fields.

The system 100 executes information processing for obtaining some sort of result with respect to certain data by assigning the first processing and the second processing to the nodes 102 in a distributed manner. A description will be given of an example in which the system 100 according to the embodiment employs Hadoop software as software for performing processing in a distributed manner.

The system 100 according to the present embodiment will be described using the terms used in Hadoop. A “Job” is a unit of processing in Hadoop. For example, processing for determining congestion information based on information indicating an amount of traffic corresponds to one job. “Tasks” are units of processing obtained by dividing a job. There are two types of tasks: Map tasks for executing Map processing, which corresponds to the first processing, and Reduce tasks for executing Reduce processing, which corresponds to the second processing. In addition, there is “shuffle and sort” by which an apparatus that executes the Map processing transmits the processing results of the Map processing to an apparatus to which a Reduce task has been assigned and the apparatus to which the Reduce task has been assigned aggregates the processing results of the Map processing based on the key fields.

Next, a description will be given of details of an environment in which a Hadoop system is constructed. Although a Hadoop system is generally constructed in one data center, A Hadoop system may also be constructed using a plurality of data centers. As a first example in which a Hadoop system is constructed using a plurality of data centers, it is now assumed that a demand arises for performing distribution processing using all of data that have been collected by the data centers in advance. In this case, when an attempt is made to aggregate all of the data collected by the plurality of data centers into one data center, it takes time to transfer the data. Thus, when the Hadoop system is constructed using the plurality of data centers, it is possible to perform distribution processing without aggregating the data.

A second example in which a Hadoop system is constructed using a plurality of data centers is a case in which, when data have been collected by a plurality of data centers in advance, transfer of the data stored in each data center is prohibited for security reasons. The data that are prohibited from being transferred are, for example, data including payroll information, personal information, and so on of employees working for a company. In this case, a condition for a node to which Map processing is to be assigned is that the node is located in the data center where the data are stored.

When a Hadoop system is constructed using a plurality of data centers, there are cases in which, in the shuffle and sort, the processing results of Map processing are transmitted to a distant node. In this case, it takes time to transmit the processing results of the Map processing, and thus the processing time of the entire MapReduce increases.

Accordingly, the assigning apparatus 101 determines, among the group of nodes 102 that are scattered at the individual locations, the node that is the closest in distance to the node 102 to which a Map task 111 has been assigned as the node 102 to which a Reduce task is to be assigned. Thus, the assigning apparatus 101 makes the processing results of the Map task 111 more difficult to be transferred to the nodes 102 at remote locations, thereby reducing an increase in the amount of time taken for the distribution processing.

By referring to distance information 110, the assigning apparatus 101 determines a distance between the node 102 to which a Map task 111 has been assigned and the node 102 to which a Reduce task is assignable, the nodes 102 being included in the node group 102. In the example illustrated in FIG. 1, the nodes 102 to which a Reduce task is assignable are assumed to be the nodes 102#2 and 102#3. In FIG. 1, blocks denoted by dotted lines indicate that a Reduce task is assignable. The node 102 to which a Reduce task is assignable transmits, to the assigning apparatus 101, a Reduce-task assignment request indicating that a Reduce task is assignable to the node 102, in order to notify the assigning apparatus 101 that a Reduce task is assignable.

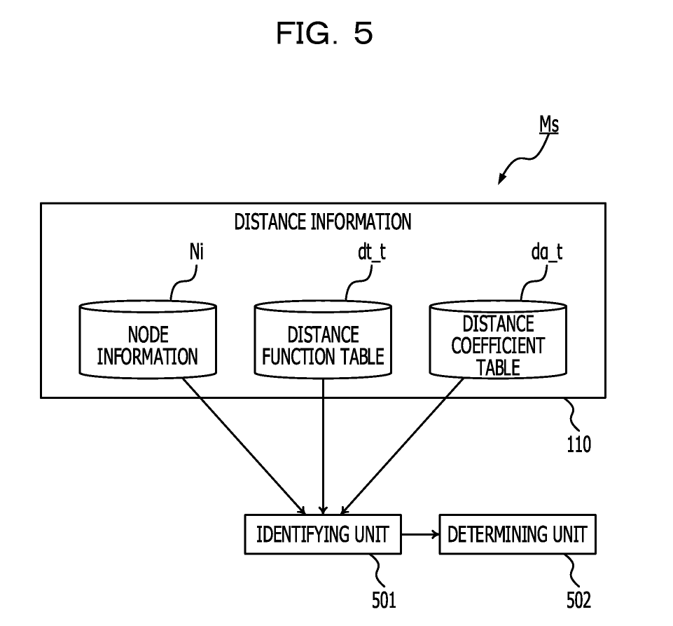

The distance information 110 is information that specifies the distance between the nodes in the node group 102. The distance information 110 that specifies the distances between the nodes may be the actual distances between the nodes or may be degrees representing the distances between the nodes. The distance information 110 is described later in detail with reference to FIG. 5. For example, the distance information 110 indicates that the distance between the nodes 102#1 and 102#2 is small, and the distance between the nodes 102#1 and 102#3 is large since the data centers 104 and 105 are distant from each other. When the distance information 110 is the example distance information described above, the assigning apparatus 101 identifies that the distance between the nodes 102#1 and 102#2 is smaller and the distance between the nodes 102#1 and 102#3 is larger.

Next, based on the identified distances, the assigning apparatus 101 determines the node 102 to which Reduce processing is to be assigned among the nodes 102 to which a Reduce task is assignable. In the example illustrated in FIG. 1, the assigning apparatus 101 determines, as the node 102 to which a Reduce task is to be assigned, the node 102#2 that is closer in distance to the node 102#1. In accordance with the result of the determination, the assigning apparatus 101 assigns the Reduce task to the node 102#2.

Example of System Configuration of Distributed Processing System

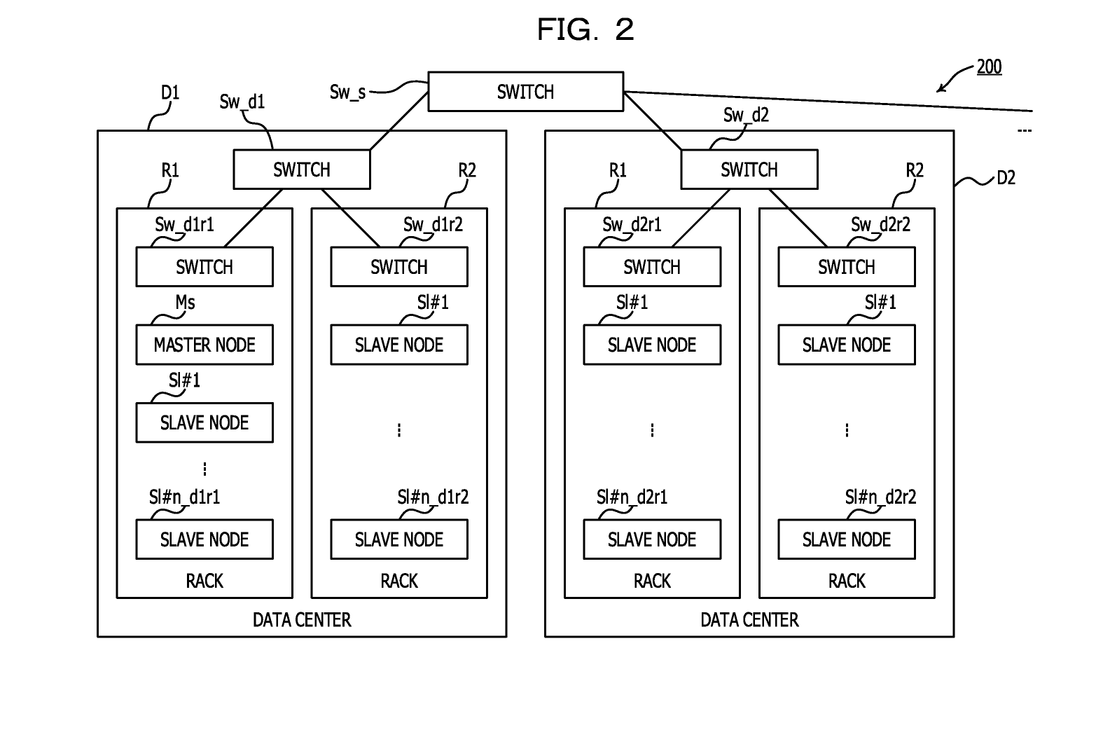

Next, a case in which the system 100 illustrated in FIG. 1 is applied to a distributed processing system will be described with reference to FIGS. 2 to 14.

FIG. 2 illustrates an example of the system configuration of a distributed processing system 200. The distributed processing system 200 illustrated in FIG. 2 is a system in which wide-area dispersed clusters that are geographically distant from each other are used to distribute data and execute MapReduce processing. The distributed processing system 200 has a switch Sw_s and a plurality of data centers, namely, data centers D1 and D2. The data centers D1 are D2 are located geographically distant from each other. The data centers D1 and D2 are coupled to each other via the switch Sw_s.

The data center D1 includes a switch Sw_d1 and two racks. The two racks included in the data center D1 are hereinafter referred to respectively as a “rack D1/R1” and a “rack D1/R2”. The rack D1/R1 and the rack D1/R2 are coupled to each other via the switch Sw_d1.

The rack D1/R1 includes a switch Sw_d1r1, a master node Ms, and n_d1r1 slave nodes, where n_d1r1 is a positive integer. The slave nodes included in the rack D1/R1 are hereinafter referred to respectively as “slave nodes D1/R1/SI#12 to D1/R1/SI#n_d1r1”. The master node Ms and the slave nodes D1/R1/SI#1 to D1/R1/SI#n_d1r1 are coupled via the switch Sw_d1r1.

The rack D1/R2 includes a switch Sw_d1r2 and n_d1r2 slave nodes, where n_d1r2 is a positive integer. The slave nodes included in the rack D1/R2 are hereinafter referred to respectively as “slave nodes D1/R2/SI#1 to D1/R2/SI#n_d1r2”. The slave nodes D1/R2/SI#1 to D1/R2/SI#n_d1r2 are coupled via the switch Sw_d1r2.

The data center D2 includes a switch Sw_d2 and two racks. The two racks included in the data center D2 are hereinafter referred to respectively as a “rack D2/R1” and a “rack D2/R2”. The rack D2/R1 and the rack D2/R2 are coupled via the switch Sw_d2.

The rack D2/R1 includes a switch Sw_d2r1 and n_d2r1 slave nodes, where n_d2r1 is a positive integer. The slave nodes included in the rack D2/R1 are hereinafter referred to respectively as “slave nodes D2/R1/SI#1 to D2/R1/SI#n_d2r1”. The slave nodes D2/R1/SI#1 to D2/R1/SI#n_d2r1 are coupled via the switch Sw_d2r1.

The rack D2/R2 includes a switch Sw_d2r2 and n_d2r2 slave nodes, where n_d2r2 is a positive integer. The slave nodes included in the rack D2/R2 are hereinafter referred to respectively as “slave nodes D2/R2/SI#1 to D2/R2/SI#n_d2r2”. The slave nodes D2/R2/SI#1 to D2/R2/SI#n_d2r2 are coupled via the switch Sw_d2r2.

Hereinafter, when any of the slave nodes included in all of the racks in all of the data centers is referred to, it may simply be referred to as a “slave node SI”. It is also assumed that the distributed processing system 200 includes n slave nodes. In this case, n is a positive integer, and there is a relationship n=n_d1r1+n_d1r2+n_d2r1+n_d2r2. In addition, the group of slave nodes included in the distributed processing system 200 may be referred to as a “slave node group SIn” by using n. The slave nodes SI#1 to SI#n and the master node Ms may also be collectively referred to simply as “nodes”.

Now, a description will be given of a correspondence with the configuration illustrated in FIG. 1. The master node Ms corresponds to the assigning apparatus 101 illustrated in FIG. 1. The slave nodes SI correspond to the nodes 102 illustrated in FIG. 1. The switches Sw_s, Sw_d1, Sw_d2, Sw_d1r1, Sw_d1r2, Sw_d2r1, and Sw_d2r2 correspond to the network 103 illustrated in FIG. 1. The data centers D1 and D2 correspond to the data centers 104 and 105 illustrated in FIG. 1.

The master node Ms is an apparatus that assigns Map processing and Reduce processing to the slave nodes SI#1 to SI#n. The master node Ms has a setting file describing a list of host names of the slave nodes SI#1 to SI#n. The slave nodes SI#1 to SI#n are apparatuses that execute the assigned Map processing and the Reduce processing.

Hardware of Master Node Ms

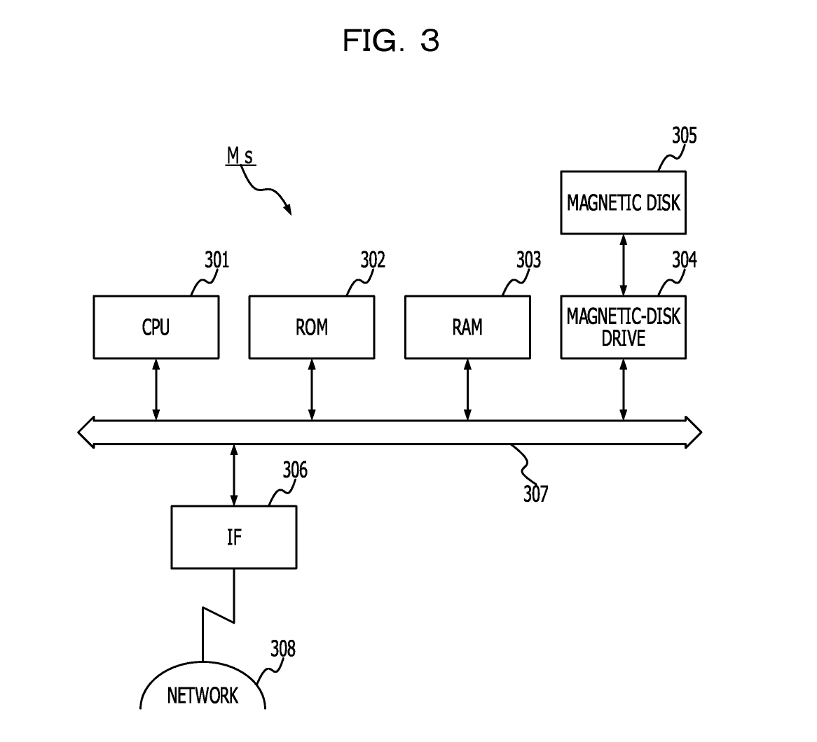

FIG. 3 is a block diagram illustrating an example of the hardware configuration of the master node Ms. As illustrated in FIG. 3, the master node Ms includes a central processing unit (CPU) 301, a read-only memory (ROM) 302, and a random access memory (RAM) 303. The master node Ms further includes a magnetic-disk drive 304, a magnetic disk 305, and an interface (IF) 306. The individual elements are coupled to each other through a bus 307.

The CPU 301 is a computational processing device that is responsible for controlling the entire master node Ms. The ROM 302 is a nonvolatile memory that stores therein programs, such as a boot program. The RAM 303 is a volatile memory used as a work area for the CPU 301. The magnetic-disk drive 304 is a control device for controlling writing/reading data to/from the magnetic disk 305 in accordance with control performed by the CPU 301. The magnetic disk 305 is a nonvolatile memory that stores therein data written under the control of the magnetic-disk drive 304. The master node Ms may also have a solid-state drive.

The IF 306 is coupled to another apparatus, such as the switch Sw_d1r1, through a communication channel and a network 308. The IF 306 is responsible for interfacing between the inside of the master node Ms and the network 308 to control output/input of data to/from an external apparatus. The IF 306 may be implemented by, for example, a modem or a local area network (LAN) adapter.

When an administrator of the master node Ms directly operates the master node Ms, the master node Ms may have an optical disk drive, an optical disk, a display, and a mouse, which are not illustrated in FIG. 3.

The optical disk drive is a control device that controls writing/reading of data to/from an optical disk in accordance with control performed by the CPU 301. Data written under the control of the optical disk drive is stored on the optical disk, and data stored on the optical disk is read by a computer.

The display displays a cursor, icons and a toolbox, as well as data, such as a document, an image, and function information. For example, the display may be implemented by a cathode ray tube (CRT) display, a thin-film transistor (TFT) liquid-crystal display, a plasma display, or the like.

The keyboard has keys for inputting characters, numerals, and various instructions to input data. The keyboard may also be a touch-panel input pad, a numeric keypad, or the like. The mouse is used for moving a cursor, selecting a range, moving or resizing a window, or the like. Instead of the mouse, the master node Ms may also have any device that serves as a pointing device. Examples include a trackball and a joystick.

The slave node SI has a CPU, a ROM, a RAM, a magnetic-disk drive, and a magnetic disk.

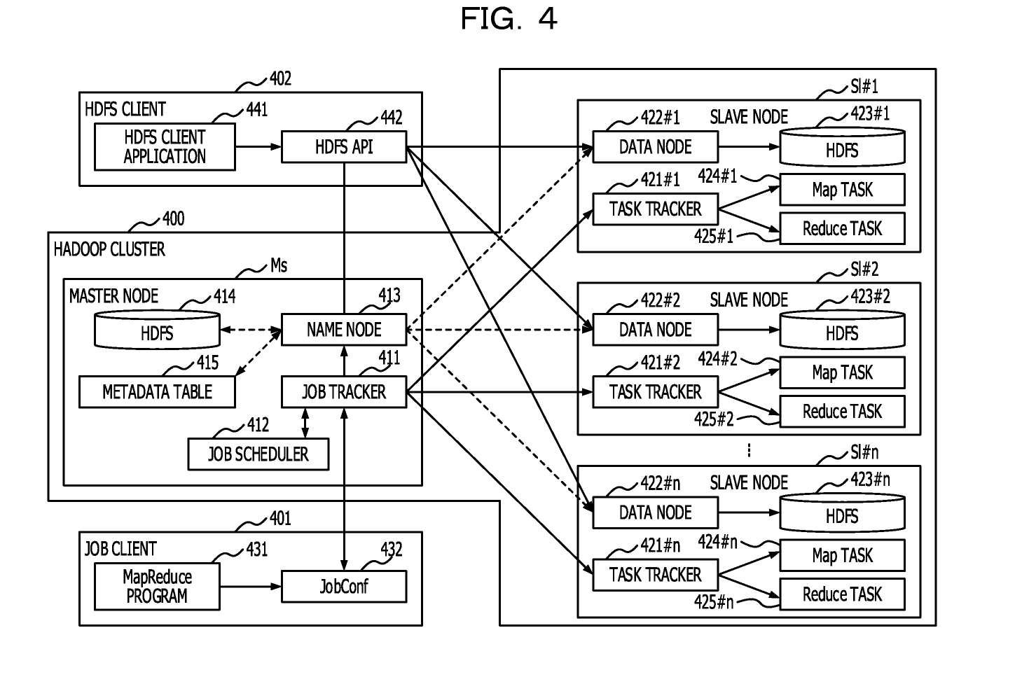

FIG. 4 illustrates an example of the software configuration of the distributed processing system. The distributed processing system 200 includes the master node Ms, the slave nodes SI#1 to SI#n, a job client 401, and a Hadoop Distributed File System (HDFS) client 402. A portion including the master node Ms and the slave nodes SI#1 to SI#n is defined as a Hadoop cluster 400. The Hadoop cluster 400 may also include the job client 401 and an HDFS client 402.

The job client 401 is an apparatus that stores therein files to be processed by MapReduce processing, programs that serve as executable files, and a setting file for files executed. The job client 401 reports a job execution request to the master node Ms.

The HDFS client 402 is a terminal for performing a file operation in an HDFS, which is a unique file system in Hadoop.

The master node Ms has a job tracker 411, a job scheduler 412, a name node 413, an HDFS 414, and a metadata table 415. The slave node SI#x has a task tracker 421#x, a data node 422#x, an HDFS 423#x, a Map task 424#x, and a Reduce task 425#x, where x is an integer from 1 to n. The job client 401 has a MapReduce program 431 and a JobConf 432. The HDFS client 402 has an HDFS client application 441 and an HDFS application programming interface (API) 442.

The Hadoop may also be implemented by a file system other than the HDFS. The distributed processing system 200 may also employ, for example, a file server that the master node Ms and the slave nodes SI#1 to SI#n can access in accordance with the File Transfer Protocol (FTP).

The job tracker 411 in the master node Ms receives, from the job client 401, a job to be executed. The job tracker 411 then assigns Map tasks 424 and Reduce tasks 425 to available task trackers 421 in the Hadoop cluster 400. The job scheduler 412 then determines a job to be executed. For example, the job scheduler 412 determines a next job to be executed among jobs requested by the job client 401. The job scheduler 412 also generates Map tasks 424 for the determined job, each time splits are input. The job tracker 411 stores a task tracker ID for identifying each task tracker 421.

The name node 413 controls file storage locations in the Hadoop cluster 400. For example, the name node 413 determines where in the HDFS 414 and HDFSs 423#1 to 423#n an input file is to be stored and transmits the file to the determined HDFS.

The HDFS 414 and the HDFSs 423#1 to 423#n are storage areas in which files are stored in a distributed manner. The HDFSs 423#1 to 423#n stores a file in units of block obtained by separating the file with physical delimiters. The metadata table 415 is a storage area that stores therein the locations of files stored in the HDFS 414 and the HDFSs 423#1 to 423#n.

The task tracker 421 causes the local slave node SI to execute the Map task 424 and/or the Reduce task 425 assigned by the job tracker 411. The task tracker 421 also notifies the job tracker 411 about the progress status of the Map task 424 and/or the Reduce task 425 and a processing completion report. When the setting file describing the list of the host names of the slave nodes SI#1 to SI#n, the list of the host names being provided in the task tracker 421, is read, the master node Ms receives a startup request. The task trackers 421 correspond to the host names of the slave nodes SI. Each task tracker 421 receives a task tracker ID from the master node Ms.

The data node 422 controls the HDFS 423 in the corresponding slave node SI. The Map task 424 executes Map processing. The Reduce task 425 executes Reduce processing. The slave node SI also executes shuffle and sort at a phase before the Reduce processing is performed. The shuffle and sort is processing for aggregating results of the Map processing. In the shuffle and sort, the results of the Map processing are re-ordered for each key, and values of the same key are collectively output to the Reduce task 425.

The MapReduce program 431 includes a program for executing Map processing and a program for executing Reduce processing. The JobConf 432 is a program describing settings of the MapReduce program 431. Examples of the settings include the number of Map tasks 424 to be generated, the number of Reduce tasks 425 to be generated, and the output destination of a processing result of the MapReduce processing.

The HDFS client application 441 is an application for operating the HDFSs. The HDFS API 442 is an API that accesses the HDFSs. For example, upon receiving a file access request from the HDFS client application 441, HDFS API 442 queries the data nodes 422 as to whether or not the corresponding file is held.

(Functions of Master Node Ms)

Next, a description will be given of the functions of the master node Ms. FIG. 5 is a block diagram illustrating an example of the functional configuration of the master node Ms. The master node Ms includes an identifying unit 501 and a determining unit 502. The identifying unit 501 and the determining unit 502 serve as control units. The CPU 301 executes a program stored in a storage device to thereby realize the functions of the identifying unit 501 and the determining unit 502. Examples of the storage device include the ROM 302, the RAM 303, and the magnetic disk 305 illustrated in FIG. 3. Alternatively, another CPU may execute the program via the IF 306 to realize the functions of the identifying unit 501 and the determining unit 502.

The master node Ms is also capable of accessing the distance information 110. The distance information 110 is stored in a storage device, such as the RAM 303 or the magnetic disk 305. The distance information 110 is information specifying the distances between the nodes SI in the slave node group Sin. The distance information 110 may also include a distance coefficient table dα_t containing information indicating the distance between the data centers to which the slave node group SIn belongs and node information Ni for identifying the data centers to which the individual nodes SI in the slave node group SIn belong. In addition, the distance information 110 may include a distance function table dt_t containing values including the number of switches provided along a transmission path between the nodes.

For example, the node information Ni includes information indicating that the slave nodes D1/R1/SI#1 to D1/R2/SI#n_d1r2 belong to the data center D1. In addition, the node information Ni includes information indicating that the slave nodes D2/R1/SI#1 to D2/R2/SI#n_d2r2 belong to the data center D2. The node information Ni also includes which of the racks the slave nodes SI belong. The node information Ni may also be the setting file described above with reference to FIG. 2.

One example of the contents of the node information Ni is the host names of the respective slave nodes D1/R1/SI#1 to D1/R2/SI#n_d1r2 when the node information Ni is the setting file described above with reference to FIG. 2. When the host names of the slave nodes SI include the identification information of the data centers, such as “D1/R1/SI#1”, the master node Ms can identify to which data center the slave node SI in question belongs.

Another example of the contents of the node information Ni is node information Ni in which the host names of the slave nodes D1/R1/SI#1 to D1/R2/SI#n_d1r2 are associated with internet protocol (IP) addresses. It is assumed that the administrator or the like of the distributed processing system 200 has divided the IP addresses according to sub-networks for each data center and has assigned the resulting IP addresses to the slave nodes SI. For example, it is assumed that the IP address assigned to the slave node SI belonging to the data center D1 is 192.168.0.X and the IP address assigned to the slave node SI belonging to the data center D2 is 192.168.1.X. By referring to the top 24 bits of the IP address of one slave node SI, the master node Ms can identify to which data center the slave node SI belongs.

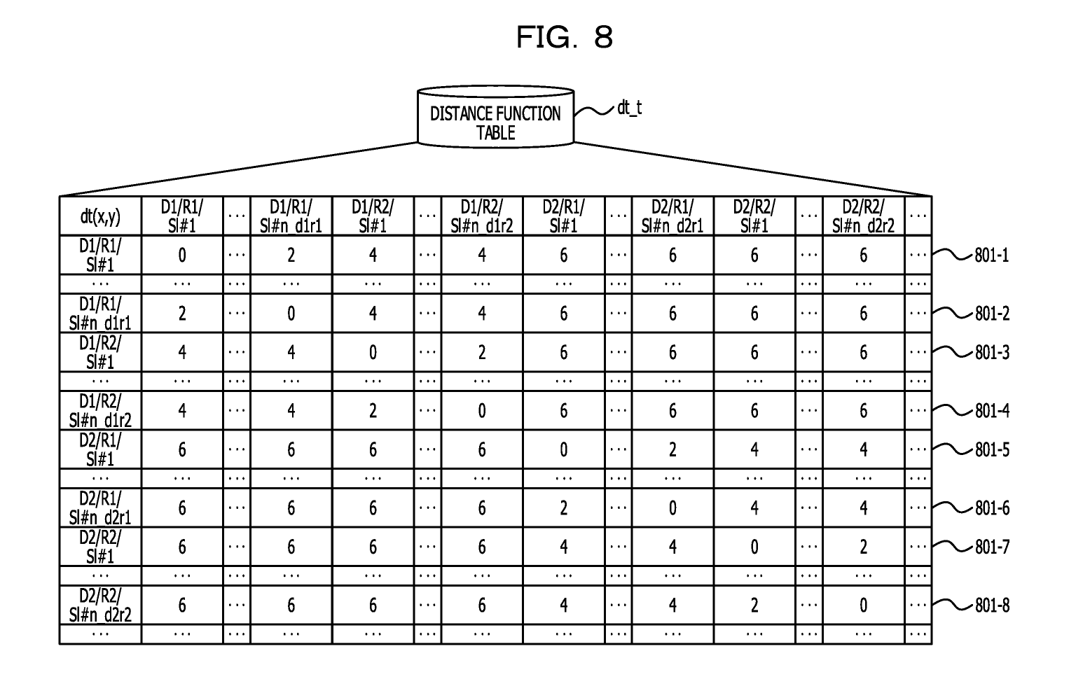

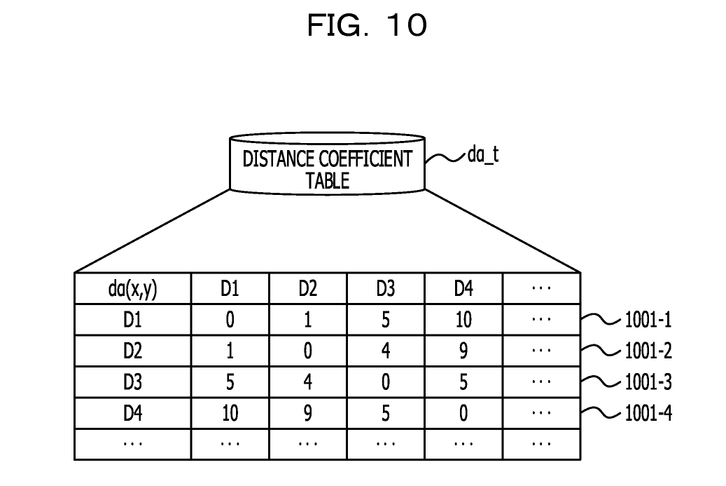

The distance function table dt_t may also contain the number of apparatuses with which the slave node SI in question communicates, in addition to the number of switches provided along the transmission path between the slave nodes SI. The contents of the distance function table dt_t are described later with reference to FIG. 8. The contents of the distance coefficient table dα_t are described later with reference to FIG. 10.

By referring to the distance information 110, the identifying unit 501 identifies the distance between the slave node SI to which a Map task 424 has been assigned and the slave node SI to which a Reduce task 425 is assignable, the slave nodes SI being included in the slave node group SIn. In the description with reference to FIG. 5, the slave node SI to which the Map task 424 has been assigned is referred to as a “slave node SI_M”, and the slave node SI to which the Reduce task 425 is assignable is referred to as a “slave node SI_R”.

For example, the slave node D1/R1/SI#1 may be the slave node SI_M and the slave node D1/R1/SI#2 may be the slave node SI_R. In addition, it is assumed that the distance information 110 indicates that the degree of the distance between the slave node D1/R1/SI#1 and the slave node D1/R1/SI#2 is “1”. In this case, the identifying unit 501 identifies that the distance between the slave node D1/R1/SI#1 and the slave node D1/R1/SI#2 is “1”.

Also, by referring to the node information Ni, the identifying unit 501 identifies, among the plurality of data centers, the data center to which the slave node SI_M belongs and the data center to which the slave node SI_R belongs. By referring to the distance coefficient table dα_t, the identifying unit 501 identifies the distance between the data center to which the slave node SI_M belongs and the data center to which the slave node SI_R belongs. The identifying unit 501 may also identify the distance between the slave node SI_M and the slave node SI_R by identifying the distance between the corresponding data centers.

For example, it is assumed that the node information Ni indicates that the data center to which the slave node SI_M belongs is the data center D1 and the data center to which the slave node SI_R belongs is the data center D2. In addition, it is assumed that the distance coefficient table dα_t indicates that the degree of the distance between the data center D1 and the data center D2 is “100”. In this case, the identifying unit 501 identifies that the distance between the slave node SI_M and the slave node SI_R is “100”.

By referring to the distance function table dt_t, the identifying unit 501 also identifies the number of switches provided along a transmission path between the slave node SI_M and the slave node SI_R. The identifying unit 501 may identify the distance between the slave node SI_M and the slave node SI_R, based on the identified number of switches and the identified distance between the data center to which the slave node SI_M belongs and the data center to which the slave node SI_R belongs.

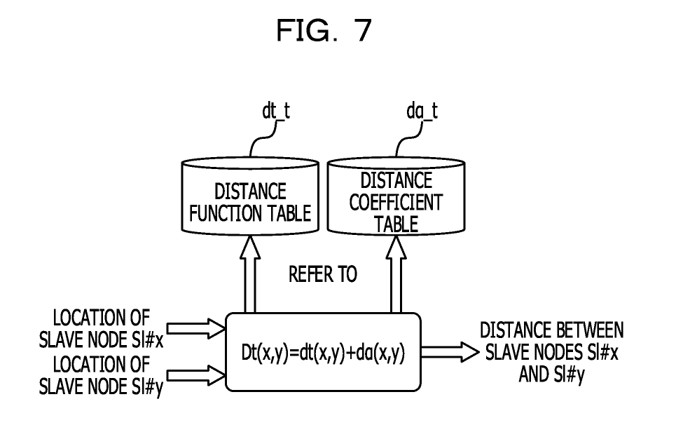

By using a distance function Dt described below with reference to FIG. 7, the identifying unit 501 identifies the distance between the slave node SI_M and the slave node SI_R. It is also assumed that, for example, the distance function table dt_t indicates that the number of switches provided along the transmission path between the slave node SI_M and the slave node SI_R is “3”. It is further assumed that the average value of the degrees of the distances between the switches in the data centers is “20”. The value “20” is a value pre-set by the administrator of the distributed processing system 200. In addition, the distance coefficient table dα_t indicates that the degree of the distance between the data center to which the slave node SI_M belongs and the data center to which the slave node SI_R belongs is “100”. In this case, the identifying unit 501 determines that the distance between the slave node SI_M and the slave node SI_R is 160 (=3×20+100).

When there are a plurality of slave nodes SI to which a Reduce task 425 is assignable, the identifying unit 501 may also identify the distance between the slave node SI_M and each of the plurality of nodes to which a Reduce task 425 is assignable, by referring to the distance information 110. For example, it is assumed that there are two slave nodes SI to which a Reduce task 425 is assignable, namely, the slave nodes SI_R1 and SI_R2. In this case, the identifying unit 501 identifies the distance between the slave node SI_M and the slave node SI_R1 and the distance between the slave node SI_M and the slave node SI_R2.

When there are a plurality of slave nodes SI to which Map tasks 424 have been assigned, the identifying unit 501 may identify the distance between the slave node SI_R and each of the slave nodes SI to which the Map tasks 424 have been assigned, by referring to the distance information 110. For example, it is assumed that there are two slave nodes SI to which Map tasks 424 have been assigned, namely, the slave nodes SI_M1 and SI_M2. In this case, the identifying unit 501 identifies the distance between the slave node SI_R and the slave node SI_M1 and the distance between the slave node SI_R and the slave node SI_M2. Data of the identified distances is stored in a storage area in the RAM 303, the magnetic disk 305, or the like.

Based on the distance identified by the identifying unit 501, the determining unit 502 determines the slave node SI to which the Reduce task 425 is to be assigned from the slave node SI_M. For example, if there is one slave node SI to which a Reduce task 425 is assignable and the distance identified by the identifying unit 501 is smaller than or equal to a predetermined threshold, the determining unit 502 determines this slave node SI as the slave node SI to which the Reduce task 425 is to be assigned. The predetermined threshold is, for example, a value specified by the administrator of the distributed processing system 200.

It is also assumed that there are a plurality of slave nodes SI to which a Reduce task 425 is assignable. In this case, the determining unit 502 may determine that the Reduce task 425 is to be assigned to the slave node SI whose distance identified by the identifying unit 501 is relatively small among the plurality of slave nodes SI to which the Reduce task 425 is assignable. For example, for determining that there are a plurality of slave nodes SI to which a Reduce task 425 is assignable, the master node Ms has a buffer that stores therein Reduce-task assignment requests received from the slave nodes SI.

For example, it is assumed that there are two slave nodes SI to which the Reduce task 425 is assignable, namely, the slave nodes SI_R1 and SI_R2. In this case, it is assumed that the identifying unit 501 has identified that the distance between the slave node SI_M and the slave node SI_R1 is “10” and the distance between the slave node SI_M and the slave node SI_R2 is “12”. The determining unit 502 then determines, of the slave nodes SI_R1 and SI_R2, the slave node SI_R1 whose distance identified by the identifying unit 501 is relatively small as the slave node SI to which the Reduce task 425 is to be assigned.

It is also assumed that there are a plurality of slave nodes SI to which Map tasks 424 have been assigned. In this case, based on the total of the distances identified in correspondence with the respective slave nodes SI to which the Map tasks 424 have been assigned, the determining unit 502 may also determine, among the slave nodes SI_R, the node to which the Reduce task 425 is to be assigned.

For example, it is assumed that there are two slave nodes SI to which the Map tasks 424 have been assigned, namely, the slave nodes SI_M1 and SI_M2. In this case, the identifying unit 501 identifies that the distance between the slave node SI_R and the slave node SI_M1 is “10” and the distance between the slave node SI_R and the slave node SI_M2 is “12”. When the value “22(=10+12)” obtained by totaling the distances is smaller than or equal to a value obtained by multiplying the number of slave nodes SI to which the Map tasks 424 have been assigned by a predetermined threshold, the determining unit 502 determines the slave node SI_R as the slave node SI to which the Reduce task 425 is to be assigned.

It is also assumed that there are a plurality of slave nodes SI to which Map tasks 424 have been assigned and a plurality of slave nodes SI to which a Reduce task 425 is assignable. In this case, the determining unit 502 calculates, for each of the slave nodes SI to which the Reduce task 425 is assignable, the total of the distances identified in correspondence with the respective slave nodes SI to which the Map tasks 424 have been assigned. The determining unit 502 may determine, as the slave node SI to which the Reduce task 425 is to be assigned, the slave node SI whose calculated distance is relatively small. Identification information for identifying the determined slave node SI is stored in a storage area in the RAM 303, the magnetic disk 305, or the like.

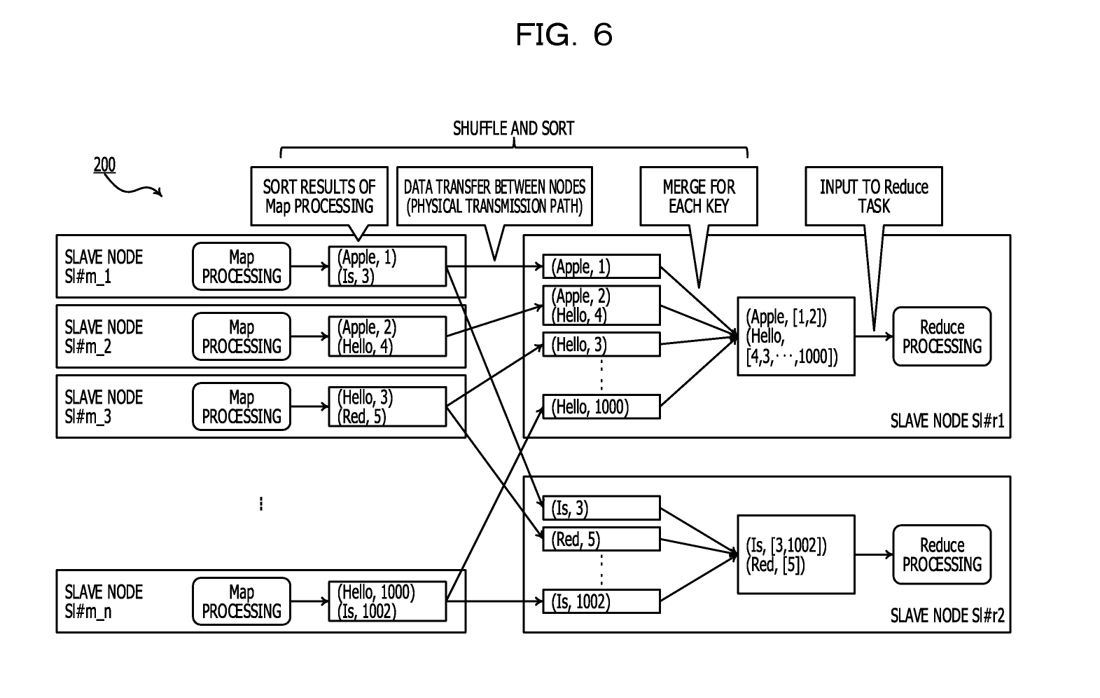

FIG. 6 illustrates an example of MapReduce processing performed by the distributed processing system according to the present embodiment. An example in which the MapReduce program 431 is a word-count program for counting the number of words that appear in a file to be processed will now be described with reference to FIG. 6. The Map processing in the word count is processing for counting, for each word, the number of words that appear in splits obtained by splitting a file. The Reduce processing in the word count is processing for calculating, for each word, a total of the number of words that appear.

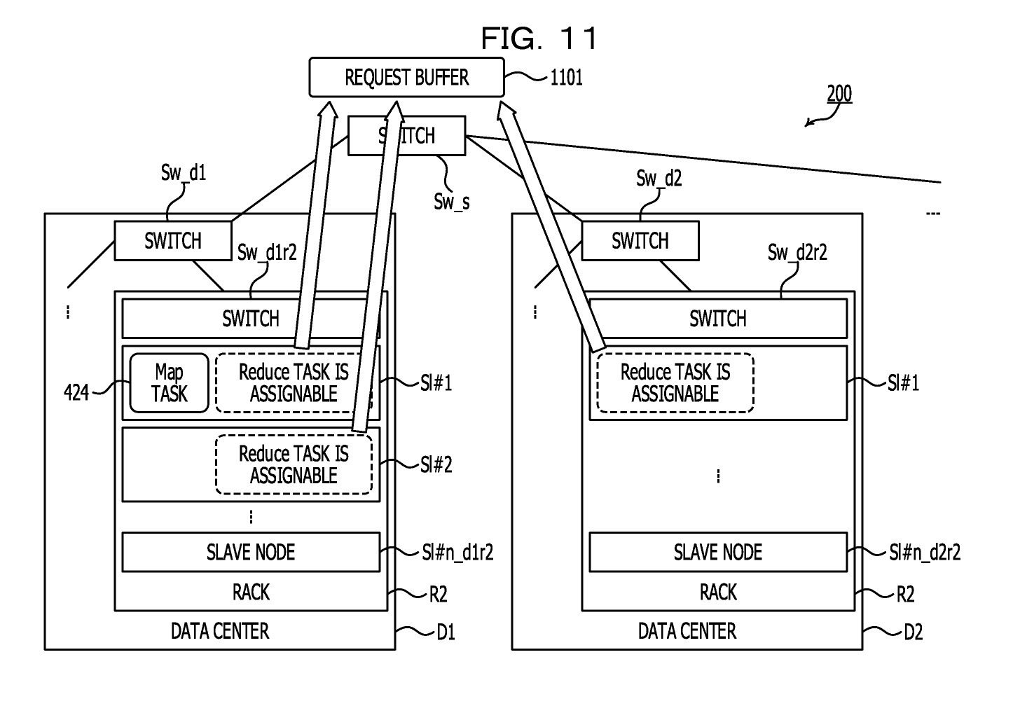

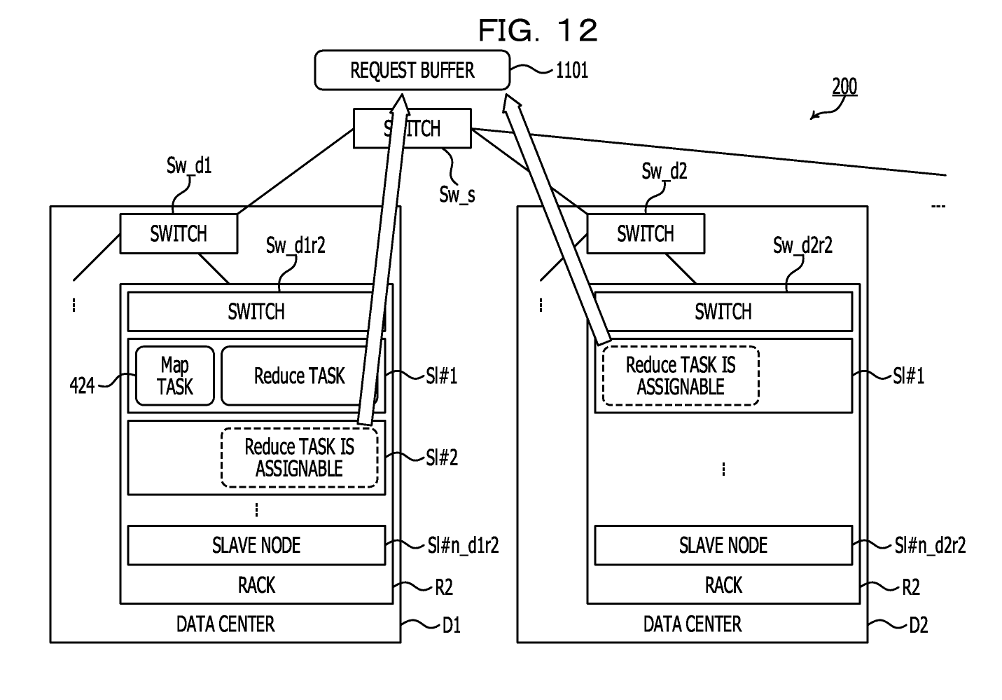

The master node Ms assigns Map processing and Reduce processing to the slave nodes SI#m_1 to SI#m_n among the slave nodes SI#1 to SI#n. The job tracker 411 receives task assignment requests from the slave nodes SI#1 to SI#n by using heartbeats and assigns Map tasks 424 to the slave nodes SI having splits. The job tracker 411 also receives task assignment requests from the slave nodes SI#1 to SI#n by using heartbeats and assigns Reduce tasks 425 to the slave node(s) in accordance with a result of assignment processing according to the present embodiment. The Reduce-task assignment processing is described later with reference to FIGS. 11 and 12. In the example illustrated in FIG. 6, the job tracker 411 assigns Reduce tasks 425 to the slave nodes SI#r1 and SI#r2.

The heartbeat from the slave node SI includes four types of information, that is, a task tracker ID, the maximum number of assignable Map tasks 424, the maximum number of assignable Reduce tasks 425, and the number of available slots for tasks. The task tracker ID is information for identifying the task tracker 421 (described above and illustrated in FIG. 4) that is the transmission source of the heartbeat, the task tracker 421 being included in the slave node SI. The master node Ms can identify the host name of the slave node SI in accordance with the task tracker ID, thus making it possible to identify the data center and the rack to which the slave node SI belongs in accordance with the task tracker ID.

The maximum number of assignable Map tasks 424 is the maximum number of Map tasks 424 that are currently assignable to the slave node S that is the transmission source of the heartbeat. The maximum number of assignable Reduce tasks 425 is the maximum number of Reduce tasks 425 that are currently assignable to the slave node SI that is the transmission source of the heartbeat. The number of available slots for tasks is the number of tasks that are assignable to the slave node SI that is the transmission source of the heartbeat.

In the Map processing, the slave nodes SI#m_1 to SI#m_n to which the Map processing is assigned count, for each word, the number of words that appear in splits. For example, in the Map processing, with respect to a certain split, the slave node SI#m_1 counts “1” as the number of appearances of a word “Apple” and counts “3” as the number of appearances of a word “Is”. The slave node SI#m_1 then outputs (Apple, 1) and (Is, 3) as a processing result of the Map processing.

Next, in shuffle and sort, the slave nodes SI#m_1 to SI#m_n to which the Map processing has been assigned sort the processing results of the Map processing. The slave nodes SI#m_1 to SI#m_n then transmit the sorted processing results of the Map processing to the slave nodes SI#r1 and SI#r2 to which the Reduce tasks have been assigned. For example, the slave node SI#m_1 transmits (Apple, 1) to the slave node SI#r1 and also transmits (Is, 3) to the slave node SI#r2.

Upon receiving the processing results of the Map processing, the slave nodes SI#r1 and SI#r2 merge, for each key, the sorted processing results of the Map processing. For example, with respect to the key “Apple”, the slave node SI#r1 merges (Apple, 1) and (Apple, 2) received from the respective slave nodes SI#m_1 and SI#m_2 and outputs (Apple, [1, 2]). In addition, with respect to a key “Hello”, the slave node SI#r1 merges received (Hello, 4), (Hello, 3), . . . , and (Hello,1000) and outputs (Hello, [4, 3, . . . , 1000]).

After the sorted processing results of the Map processing are merged for each key, the slave nodes SI#r1 and SI#r2 input the result of the merging to the respective Reduce tasks 425. For example, the slave node SI#r1 inputs (Apple, [1, 2]) and (Hello, [4, 3, . . . , 1000]) to the Reduce task 425.

FIG. 7 is a block diagram of the distance function Dt. The distance function Dt is given according to equation (1) below.

Dt(x,y)=dt(x,y)+dα(x,y) (1)

In this case, x represents the ID of the slave node SI to which Map processing has been assigned, y represents the ID of the slave node SI to which Reduce processing is assignable, and dt(x, y) is a distance function for determining a value indicating a relative positional relationship between the slave node SI#x and the slave node SI#y. More specifically, the distance function dt(x, y) indicates the number of arrivals of data to the switches or the nodes when the data is transmitted from the slave node SI#x to the slave node SI#y. The distance function dt refers to the distance function table dt_t to output a value. An example of the contents of the distance function table dt_t is described later with reference to FIG. 8.

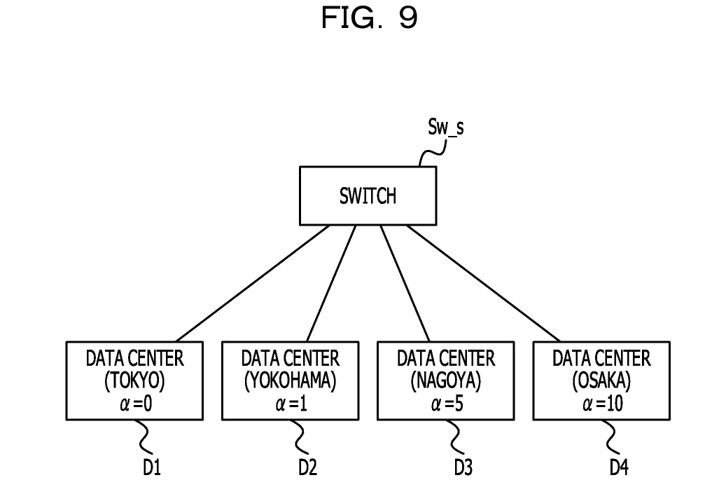

In equation (1), dα(x, y) is a distance coefficient serving as a degree representing the physical distance between the slave node SI#x and the slave node SI#y. The distance coefficient is determined by referring to the distance coefficient table dα_t. An example of setting the distance coefficient is described later with reference to FIG. 9. An example of the contents of the distance coefficient table dα_t is described later with reference to FIG. 10.

For example, the master node Ms uses equation (1) to calculate the distance between the slave node D1/R1/SI#1 and the slave node D1/R1/SI#n_d1r1 in a manner noted below.

Dt(D1/R1/SI#1, D1/R1/SI#n_{—}d1r1)=dt(D1/R1/SI#1, D1/R1/SI#n_{—}d1r1)+dα(D1/R1/SI#1, D1/R1/SI#n_{—}d1r1)=2+0=2.

FIG. 8 illustrates an example of the contents of the distance function table dt_t. The distance function table dt_t is a table in which the number of apparatuses including the slave node SI with which the slave node SI in question communicates and the switches provided along the transmission path between the slave nodes SI is stored for each combination of the slave nodes SI. The distance function table dt_t illustrated in FIG. 8 includes records 801-1 to 801-8. For example, the record 801-1 contains the number of apparatuses including the slave node SI with which the slave node D1/R1/SI#1 communicates and the switches provided along the transmission path between slave node D1/R1/SI#1 and each of the slave nodes SI included in the distributed processing system 200.

For example, for the combination of the same slave nodes SI, the number of apparatuses including the slave node SI with which the slave node SI in question communicates and the switches provided along the transmission path is “0”. Also, for communication between the slave node SI in question and another slave node SI in the same rack, the number of apparatuses including the other slave node SI and the switches provided along the transmission path between the slave node SI in question and the other slave node SI is “2”. In addition, for communication between the slave node SI in question and another slave node SI in another rack in the same data center, the number of apparatuses including the other slave node SI and the switches provided along the transmission path between the slave node SI in question and the other slave node SI is “4”. In addition, for communication between the slave node SI in question and the slave node SI in another data center, the number of apparatuses including the slave node SI and the switches provided along the transmission path between the slave node SI in question and the slave node SI is “6”.

For example, the distance function table dt_t illustrated in FIG. 8 indicates that the number of apparatuses for the dt(D1/R1/SI#1, D1/R1/SI#n_d1r1) is “2”. The reason why the number of apparatuses is “2” is that, during transmission of data from the slave node SI#1 to the slave node D1/R1/SI#n_d1r1, the switch and the node at which the data arrives are the switch Sw_d1r1 and the slave node D1/R1/SI#n_d1r1.

The distance function table dt_t is stored in a storage area in the master node Ms. The distance function table dt_t is updated when it is modified by the master node Ms included in the Hadoop cluster 400 or when a slave node SI is added or any of the slave nodes is SI is removed. The distance function table dt_t may also be updated by the administrator of the distributed processing system 200. Alternatively, for example, when a slave node SI is added, the master node Ms may obtain the relative positional relationship between the added slave node SI and the slave nodes SI other than the added slave node SI, to update the distance function table dt_t.

FIG. 9 illustrates an example of setting the distance coefficients. A case in which data centers D1 to D4 exist as the data centers included in the distributed processing system 200 will now be described with reference to FIG. 9. The data centers D1 to D4 are scattered at individual locations. For example, it is assumed that the data center D1 is located in Tokyo, the data center D2 is located in Yokohama, the data center D3 is located in Nagoya, and the data center D4 is located in Osaka.

In this case, when the transmission path between the data centers D1 and D2 is compared with the transmission path between the data centers D1 and the D3, the transmission path between the data centers D1 and D3 is longer. The longer the transmission path is, the larger the amount of time it takes to transfer data. In the present embodiment, information indicating the distances between the data centers is pre-set in the distance coefficient table dα_t, and dα(x, y) is determined by referring to the distance coefficient table dα_t.

The information indicating the distances between the data centers may include the value of the actual distances between the data centers or may be a relative coefficient indicating the distances between the data centers so as to facilitate calculation. For example, when a relative coefficient α indicating the distance between the data centers D1 and D2 is “1”, the relative coefficient α indicating the distance between the data centers D1 and D3 is set to “5”. The administrator of the distributed processing system 200 may set the information indicating the distances between the data centers, or the master node Ms may calculate the distances between the data centers through transmission of data to/from the data centers and measuring a delay involved in the transmission.

FIG. 10 illustrates an example of the contents of the distance coefficient table. The distance coefficient table dα_t stores therein, for each pair of data centers, information indicating the distance between the data centers. The distance coefficient table dα_t illustrated in FIG. 10 includes records 1000-1 to 1000-4. For example, the record 1000-1 contains information indicating the distance between the data center D1 and each of the data centers D2, D3, and D4 included in the distributed processing system 200. For example, the distance Dα(D1, D2) between the data center D1 and the data center D2 is “1”.

The distance coefficient table dα_t is stored in a storage area in the master node Ms. The distance coefficient table dα_t is updated when it is modified by the data centers included in the Hadoop cluster 400 or when the number of data centers changes. The administrator of the distributed processing system 200 may update the distance coefficient table dα_t. Alternatively, the master node Ms may update the distance coefficient table dα_t through transmission of data to/from the data centers, measuring a delay involved in the transmission, and calculating the distance between the data centers.

Next, an example of determining the node to which a Reduce task 425 is to be assigned will be described with reference to FIGS. 11 and 12. In FIGS. 11 and 12, blocks denoted by dotted lines indicate available slots to which Reduce tasks 425 are assignable.

FIG. 11 illustrates a first example of determining the node to which a Reduce task is to be assigned. The distributed processing system 200 illustrated in FIG. 11 is in a state in which the master node Ms has assigned a Map task 424 to the slave node D1/R2/SI#1. The distributed processing system 200 illustrated in FIG. 11 is also in a state in which each of the slave nodes D1/R2/SI#1, D1/R2/SI#2, and D2/R2/SI#1 has one available slot for a Reduce task 425. In addition, the distributed processing system 200 illustrated in FIG. 11 is in a state in which the master node Ms has received Reduce-task assignment requests from the slave nodes D1/R2/SI#1, D1/R2/SI#2, and D2/R2/SI#1 by using heartbeats. The master node Ms stores the received Reduce-task assignment requests in a request buffer 1101.

The request buffer 1101 is a storage area for storing Reduce-task assignment requests. The request buffer 1101 is included in a storage device, such as the RAM 303 or the magnetic disk 305, in the master node Ms. All information included the heartbeats may be stored in the request buffer 1101 or the task tracker IDs and the maximum number of assignable Reduce tasks 425 may be stored therein.

The master node Ms decides whether or not a Map task 424 has been assigned to any of the slave nodes SI that have issued the Reduce-task assignment requests stored in the request buffer 1101.

In the example illustrated in FIG. 11, since the Map task 424 has been assigned to the slave node D1/R2/SI#1, the master node Ms decides whether or not the maximum number of Reduce tasks 425 have been assigned to the slave node D1/R2/SI#1. In the example illustrated in FIG. 11, since the slave node D1/R2/SI#1 has one available slot for a Reduce task 425 and the maximum number of Reduce tasks 425 have not been assigned, the master node Ms assigns the Reduce task 425 to the slave node D1/R2/SI#1.

FIG. 12 illustrates a second example of determining the node to which a Reduce task 424 is to be assigned. The distributed processing system 200 illustrated in FIG. 12 is in a state in which the master node Ms has assigned a Map task 424 to the slave node D1/R2/SI#1. The distributed processing system 200 illustrated in FIG. 12 is also in a state in which each of the slave nodes D1/R2/SI#2 and D2/R2/SI#1 has one available slot for the Reduce task 425. In addition, the distributed processing system 200 illustrated in FIG. 12 is in a state in which the master node Ms has received Reduce-task assignment requests from the slave nodes D1/R2/SI#2 and D2/R2/SI#1 by using heartbeats. The master node Ms stores the received Reduce-task assignment requests in the request buffer 1101.

The master node Ms decides whether or not a Map task 424 has been assigned to any of the slave nodes SI that have issued the Reduce-task assignment requests stored in the request buffer 1101.

In the example illustrated in FIG. 12, a Map task 424 has not been assigned to any of the slave nodes SI that have issued the Reduce-task assignment requests. Accordingly, the master node Ms calculates the distance function Dt(x, y) to identify the distance between the slave node D1/R2/SI#1 and each of the slave nodes SI that have issued the Reduce-task assignment requests.

The master node Ms identifies the distance between the slave node D1/R2/SI#1 and the slave node D1/R2/SI#2 by calculating the distance function Dt(x, y) in the following manner.

Dt(D1/R2/SI#1, D1/R2/SI#2)=dt(D1/R2/SI#1, D1/R2/SI#2)+dα(D1/R2/SI#1, D1/R2/SI#2)=2+0=2.

The master node Ms further identifies the distance between the slave node D1/R2/SI#1 and the slave node D2/R2/SI#1 by calculating the distance function Dt(x, y) in the following manner.

Dt(D1/R2/SI#1, D2/R2/SI#1)=dt(D1/R2/SI#1, D2/R2/SI#2)+dα(D1/R2/SI#1, D2/R2/SI#2)=6+1=7.

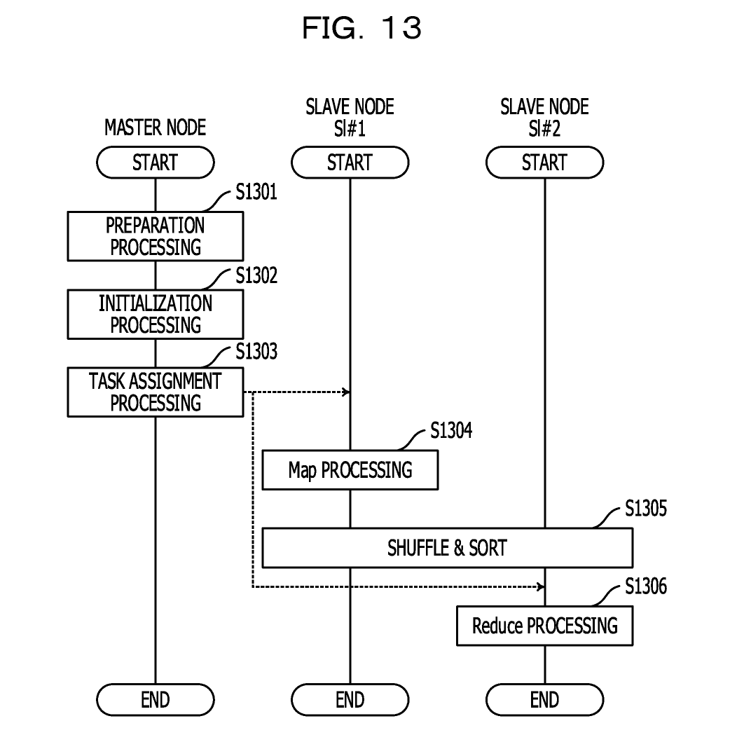

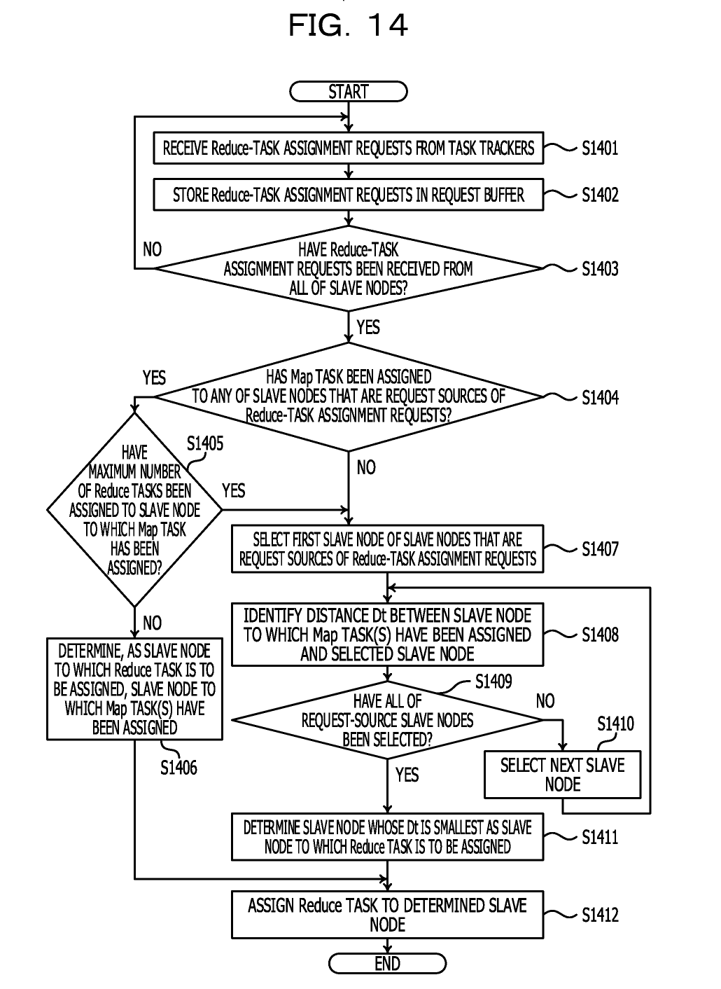

Thus, the master node Ms assigns the Reduce task 425 to the slave node D1/R2/SI#2 whose distance to the slave node D1/R2/SI#1 is smaller. Next, processing performed by the distributed processing system 200 will be described with reference to flowcharts illustrated in FIGS. 13 and 14.

FIG. 13 is a flowchart illustrating an example of a procedure for the MapReduce processing. The MapReduce processing is processing executed upon reception of a job execution request. A case in which two slave nodes SI, namely, the slave nodes SI#1 and SI#2, execute the MapReduce processing will now be described by way of example with reference to FIG. 13. In the master node Ms, the job tracker 411 and the job scheduler 412 execute the MapReduce processing in cooperation with each other. In the slave nodes SI#1 and SI#2, the task tracker 421, the Map task 424, and the Reduce task 425 execute the MapReduce processing in cooperation with each other. In the flowchart in FIG. 13, it is assumed that the Map task 424 is assigned to the slave node SI#1 and the Reduce task 425 is assigned to the slave node SI#2.

The master node Ms executes preparation processing (step S1301). The preparation processing is processing executed before a job is executed. Specifically, the job tracker 411 in the master node Ms executes the preparation processing. In the preparation processing, upon receiving a job execution request indicating a program name and an input file name, the job client 401 generates a job ID, obtains splits from an input file, and starts the MapReduce program 431.

After finishing the process in step S1301, the master node Ms executes initialization processing (step S1302). The initialization processing is processing for initializing the job. The job tracker 411 and the job scheduler 412 in the master node Ms execute the initialization processing in cooperation with each other. Upon receiving a job initialization request from the job client 401, the job tracker 411 stores the initialized job in an internal queue in the initialization processing. The job scheduler 412 periodically decides whether or not any job is stored in the internal queue. The job scheduler 412 retrieves the job from the internal queue and generates Map tasks 424 for respective splits.

After finishing the process in step S1302, the master node Ms executes task assignment processing (step S1303). The task assignment processing is processing for assigning the Map tasks 424 to the slave nodes SI. The job tracker 411 executes the task assignment processing after the job scheduler 412 generates the Map tasks 424. In the task assignment processing, by referring to communication of heartbeats received from the task trackers 421, the job tracker 411 determines the slave nodes SI to which the Map tasks 424 are to be assigned and the slave nodes SI to which the Reduce tasks 425 are to be assigned.

The heartbeat communication includes the number of tasks that are newly executable by each slave node SI. For example, it is assumed that the maximum number of tasks that are executable by the slave node SI in question is “5” and a total of three tasks including the Map tasks 424 and the Reduce task 425 are being executed by the slave node SI. In this case, the slave node SI in question issues a notification to the master node Ms through the heartbeat communication including information indicating that the number of tasks that are newly executable is “2”. The job tracker 411 determines, among the slave nodes SI#1 to SI#n, the slave node SI having a split as the slave node SI to which the Map task 424 is to be assigned. A procedure of the processing for determining the slave node SI to which the Reduce task 425 is to be assigned is described later with reference to FIG. 14.

The slave node SI#1 to which the Map task 424 has been assigned executes the Map processing (step S1304). The Map processing is processing for generating (key, value) from a split to be processed. The task tracker 421#1 and the Map task 424#1 assigned to the slave node SI#1 execute the Map processing in cooperation with each other. In the Map processing, the task tracker 421#1 copies the MapReduce program 431 from the HDFS to the local storage area in the slave node SI#1. The task tracker 421#1 then copies the split from the HDFS to the local storage area in the slave node SI#1. With respect to the split, the Map task 424#1 executes the Map processing in the MapReduce program 431.

After the process in step S1304 is finished, the slave nodes SI#1 and SI#2 execute shuffle and sort (step S1305). The shuffle and sort is processing for aggregating the processing results of the Map processing into one or more processing results.

The slave node SI#1 re-orders the processing results of the Map processing and issues, to the master node Ms, a notification indicating that the Map processing is completed. Upon receiving the notification, the master node Ms issues, to the slave node SI#1 that has completed the Map processing, an instruction indicating that the processing results of the Map processing are to be transmitted. Upon receiving the instruction, the slave node SI#1 transmits the re-ordered processing results of the Map processing to the slave node SI#2 to which the Reduce task 425 is assigned. Upon receiving the re-ordered processing results of the Map processing, the slave node SI#2 merges, for each key, the processing results of the Map processing and inputs the merged result to the Reduce task 425.

After the process in step S1305 is finished, the slave node SI#2 executes the Reduce processing (step S1306). The Reduce processing is processing for outputting the aggregated processing result as a processing result of the job. The Reduce task 425 executes the Reduce processing. The Reduce task 425#2 in the slave node SI#2 executes the Reduce processing in the MapReduce program 431 with respect to a group of records having the same value in the key fields.

After the process in step S1306 is finished, the distributed processing system 200 ends the MapReduce processing. By executing the MapReduce processing, the distributed processing system 200 may present the output result to an apparatus that has requested the job client 401 to execute the job.

FIG. 14 is a flowchart illustrating an example of a procedure of Reduce-task assignment node determination processing. The Reduce-task assignment node determination processing is processing for determining the slave node SI to which a Reduce task 425 is to be assigned.

The master node Ms receives, as Reduce-task assignment requests, heartbeats from the task trackers 421 in the slave nodes SI (step S1401). Next, the master node Ms stores the received Reduce-task assignment requests in the request buffer 1101 (step S1402). Subsequently, the master node Ms decides whether or not the Reduce-task assignment requests have been received from all of the slave nodes SI (step S1403). When there is any slave node SI from which the Reduce-task assignment request has not been received (NO in step S1403), the process of the master node Ms returns to step S1401.

When the Reduce-task assignment requests have been received from all of the slave nodes SI (YES in step S1403), the master node Ms decides whether or not a Map task 424 has been assigned to any of the slave nodes SI that are the request sources of the Reduce-task assignment requests (step S1404). When a Map task 424 has been assigned to any of the slave nodes SI (YES in step S1404), the master node Ms decides whether or not a maximum number of Reduce tasks 425 have been assigned to the slave node SI to which the Map task 424 has been assigned (step S1405). When a maximum number of Reduce tasks 425 have not been assigned (NO in step S1405), the master node Ms determines, as the slave node SI to which the Reduce task 425 is to be assigned, the slave node SI to which the Map task(s) 424 have been assigned (step S1406).

It is now assumed that, in the process in step S1406, there are a plurality of slave nodes SI to which Map tasks 424 have been assigned. In this case, the master node Ms may determine, as the slave node SI to which the Reduce task 425 is to be assigned, any of the plurality of slave nodes SI to which the Map tasks 424 have been assigned.

The master node Ms may also identify, for each of the pairs of the slave nodes SI that are the request sources of the Reduce-task assignment requests and the plurality of slave nodes SI to which the Map tasks 424 have been assigned, the distance Dt between the request-source slave node SI and the slave node SI to which the Map task(s) 424 have been assigned. The master node Ms then calculates, for each of the request-source slave nodes SI, the total of the distances Dt between the request-source slave nodes SI and the slave nodes SI to which the Map task(s) 424 have been assigned. Subsequently, the master node Ms determines, as the slave node SI to which the Reduce task 425 is to be assigned, the request-source slave node SI whose total distance is the smallest.

For example, it is assumed that the slave nodes SI to which Map tasks have been assigned are the slave nodes D1/R1/SI#1, D1/R1/SI#2, and D2/R1/SI#1. It is further assumed that the slave nodes SI that are the request sources of the Reduce-task assignment requests are the slave nodes D1/R1/SI#1 and D2/R1/SI#1. In this case, the master node Ms calculates the following six Dt( ).

Dt(D1/R1/SI#1, D1/R1/SI#1)=0+0=0

Dt(D1/R1/SI#2, D1/R1/SI#1)=2+0=2

Dt(D2/R1/SI#1, D1/R1/SI#1)=6+1=7

Dt(D1/R1/SI#1, D2/R1/SI#1)=6+1=7

Dt(D1/R1/SI#2, D2/R1/SI#1)=6+1=7

Dt(D2/R1/SI#1, D2/R1/SI#1)=0+0=0

The master node Ms determines “9” (=0+2+7) as the total of the distances Dt for the slave node D1/R1/SI#1, which is the request-source slave node SI. Similarly, the master node Ms determines “14” (=7+7+0) as the total of the distances Dt for the slave node D2/R1/SI#1, which is the request-source slave node SI. Subsequently, the master node Ms determines the slave node D1/R1/SI#1 whose total distance Dt is smaller as the slave node SI to which the Reduce task 425 is to be assigned.

When a Map task 424 has not been assigned to any of the slave nodes SI (NO in step S1404) or when a maximum number of Reduce tasks 425 have been assigned (YES in step S1405), the master node Ms selects the first slave node SI of the slave nodes SI that are the request sources of the Reduce-task assignment requests (step S1407). Next, the master node Ms identifies the distance Dt between the slave node SI to which the Map task(s) 424 have been assigned and the selected slave node SI (step S1408).

Subsequently, the master node Ms decides whether or not all of the request-source slave nodes SI have been selected (step S1409). When there is any request-source slave node SI that has not been selected (NO in step S1409), the master node Ms selects the next slave node SI of the request-source slave nodes SI (step S1410). The process of the master node Ms then proceeds to step S1408.

When all of the request-source slave nodes SI have been selected (YES in step S1409), the master node Ms determines the slave node SI whose Dt is the smallest as the slave node SI to which the Reduce task 425 is to be assigned (step S1411). In the process in step S1411, when there are a plurality of slave nodes SI to which Map tasks 424 have been assigned, the master node Ms may also perform processing that is similar to the processing using Dt in the process in step S1406.

After finishing the process in step S1406 or S1411, the master node Ms assigns the Reduce task 425 to the determined slave node SI (step S1412). After finishing the process in step S1412, the master node Ms ends the Reduce-task assignment node determination processing. By executing the Reduce-task assignment node determination processing, the master node Ms can assign a Reduce task 425 to the slave node SI that is physically close to the slave node SI to which a Map task 424 has been assigned.

Although the decision in the process in step S1403 has been made as to whether or not Reduce-task assignment requests have been received from all of the slave nodes SI, the master node Ms may also follow one of first to third decision procedures described below. As the first decision procedure, the master node Ms may make a decision as to whether or not a predetermined amount of time has passed after initial reception of a Reduce-task assignment request.

As the second decision procedure, the master node Ms may make a decision as to whether or not Dt is smaller than or equal to a predetermined threshold, by identifying Dt between the slave node SI to which a Map task 424 has been assigned and the slave node SI that has issued a Reduce-task assignment request. When the second decision procedure is employed, the master node Ms assigns a Reduce task 425 to the slave node SI whose Dt is smaller than or equal to the predetermined threshold.

As the third decision procedure, the master node Ms may make a decision as to whether or not the amount of information stored in the request buffer 1101 has reached a predetermined amount. For example, if the number of Reduce-task assignment requests that can be stored in the request buffer 1101 is “10” and the number of Reduce-task assignment requests that are stored in the request buffer 1101 reaches “8”, then the master node Ms may decide that the result in step S1403 is YES.

As described above, based on the distance between the slave nodes SI in the slave node group SIn, the master node Ms determines the slave node SI to which a Reduce task 425 is to be assigned among the nodes to which the Reduce task 425 is assignable. Typically, it is insufficient to represent the distance between slave nodes SI by using the number of switches provided along a transmission path between the slave nodes SI. Compared with the method based on the number of switches provided along a transmission path between slave nodes SI, the master node Ms according to the present embodiment can reduce the amount of time taken to transfer the processing results of Map tasks 424. As a result of the reduced amount of time taken to transfer the processing results of Map tasks 424, the distributed processing system 200 can reduce the amount of time taken for the MapReduce processing.

Although a case in which the distributed processing system 200 is constructed using a plurality of data centers has been assumed in the present embodiment, the assigning method according to the present embodiment may also be applied to a case in which the distributed processing system 200 is constructed using a single data center. Even if the distributed processing system 200 is constructed by one data center, there are cases in which the distances between the slave nodes SI and the switch may differ from one slave node SI to another. In this case, compared with the method in which the slave node SI to which a Reduce task 425 is to be assigned is determined based on the number of switches provided along the transmission path between the slave nodes SI, the assigning method according to the present embodiment can reduce the amount of time taken to transfer the processing results of Map tasks 424.

In addition, according to the master node Ms, information indicating the distances between the data centers and information for identifying the data centers to which the respective slave nodes SI in the slave node group SIn belong may also be used to determine the slave node SI to which a Reduce task 425 is to be assigned. The amount of the information indicating the distances between the data centers and the information for identifying the data centers to which the respective slave nodes SI in the slave node group SIn belong is smaller than the amount of information for identifying the distances between the individual slave nodes SI in the slave node group SIn. The distances between the slave nodes SI are also greatly dependent on the distances between the data centers. Accordingly, the master node Ms can identify the distances between the slave nodes SI with a smaller amount of information than the amount of information for identifying the distances between the slave nodes SI and can also reduce the time taken to transfer the processing results of Map tasks 424.

In addition, according to the master node Ms, the node to which a Reduce task 425 is to be assigned may also be determined based on the distances between the data centers to which the slave nodes SI belong and the number of switches provided along the transmission path between the slave nodes SI. With this arrangement, compared with a case in which only the distances between the data centers to which the slave nodes SI belong are used, the master node Ms can more accurately identify the distances between the slave nodes SI and can reduce the amount of time taken to transfer the processing results of Map tasks 424.

According to the master node Ms, when there are a plurality of slave nodes SI to which a Reduce task 425 is assignable, the Reduce task 425 may also be assigned to the slave node SI whose identified distance is relatively small among the plurality of slave nodes SI. With this arrangement, since the master node Ms assigns the Reduce task 425 to the slave node SI whose transmission path is shorter, it is possible to reduce the amount of time taken to transfer the processing result of the Map task 424.

In addition, according to the master node Ms, when there are a plurality of slave nodes SI to which Map tasks 424 have been assigned, the slave node SI to which a Reduce task 425 is to be assigned may also be determined based on the total of the distances identified in correspondence with the plurality of slave nodes SI. With this arrangement, the master node Ms makes it possible to reduce the amount of time taken to transfer the processing results of the Map processing which are transmitted by the slave nodes SI to which the Map tasks 424 have been assigned.

A computer, such as a personal computer or a workstation, may be used to execute a prepared assignment program to realize the assigning method described above in the present embodiment. The assignment program is recorded to a computer-readable recording medium, such as a hard disk, a flexible disk, a compact disc read only memory (CD-ROM), a magneto-optical (MO) disk, or a digital versatile disc (DVD), is subsequently read therefrom by the computer, and is executed thereby. The assignment program may also be distributed over a network, such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An assigning method comprising:
identifying a distance between one or more first nodes to which first processing is assigned and one or more second nodes to which second processing to be performed on a processing result of the first processing is assignable, the first and second nodes being included in a plurality of nodes that are capable of performing communication; and
determining a third node to which the second processing is to be assigned, based on the distance identified by the identifying, the third node being included in the one or more second nodes.

2. The assigning method according to claim 1,
wherein the identifying comprises referring to information indicating a distance between the nodes of the plurality of the nodes.

3. The assigning method according to claim 1,
wherein each of the plurality of nodes belongs to any of a plurality of data centers including a first data center to which the first node belongs and one or more second data centers to which the one or more second nodes belong, and
the identifying identifies a distance between the first node and the one or more second nodes, based on the distance between the first data center and the one or more second data centers.

4. The assigning method according to claim 3, wherein the identifying comprises referring to information indicating a distance between the data centers of the plurality of data centers and information for identifying the data center to which each of the nodes belongs, the data center being included in the plurality of data centers.

5. The assigning method according to claim 4,
wherein the referring comprises referring to information indicating the number of switch apparatuses provided along a communication path between the nodes.

6. The assigning method according to claim 1,
wherein, when the second processing is assignable to the second nodes, the determining determines, as the third node, the node whose distance identified by the identifying is relatively small, the node being included in the second nodes.

7. The assigning method according to claim 1,
wherein, when the first processing is assigned to the first nodes of the plurality of nodes, the identifying identifies a distance between each of the first nodes and the one or more second nodes, and
the determining determines the third node included in the one or more second nodes, based on a total of the distances identified by the identifying in correspondence with each of the first nodes.

8. An apparatus comprising:
a memory; and
a processor coupled to the memory and configured to:
identify a distance between one or more first nodes to which first processing is assigned and one or more second nodes to which second processing to be performed on a processing result of the first processing is assignable, the first and second nodes being included in a plurality of nodes that are capable of performing communication, and
determine a third node to which the second processing is to be assigned, based on the distance identified, the third node being included in the one or more second nodes.

9. A system comprising:
one or more first nodes;
one or more second nodes; and
an apparatus including a processor and a memory, and coupled to the first nodes and the second, wherein the processor is configured to:
identify a distance between one or more first nodes to which first processing is assigned and one or more second nodes to which second processing to be performed on a processing result of the first processing is assignable, the first and second nodes being included in a plurality of nodes that are capable of performing communication, and
determine a third node to which the second processing is to be assigned, based on the distance identified, the third node being included in the one or more second nodes.

10. The system according to claim 9,
wherein the processor is configured to refer to information indicating a distance between the nodes of the plurality of the nodes.

11. The system according to claim 9,
wherein each of the plurality of nodes belongs to any of a plurality of data centers including a first data center to which the first node belongs and one or more second data centers to which the one or more second nodes belong, and
the processor is configured to identify a distance between the first node and the one or more second nodes, based on the distance between the first data center and the one or more second data centers.

12. The system according to claim 11,
wherein the processor is configured to refer to information indicating a distance between the data centers of the plurality of data centers and information for identifying the data center to which each of the nodes belongs, the data center being included in the plurality of data centers.

13. The system according to claim 12,
wherein the processor is configured to refer to information indicating the number of switch apparatuses provided along a communication path between the nodes.

14. The system according to claim 9,
wherein the processor is configured to determine the node whose distance identified by the identifying is relatively small as the third node when the second processing is assignable to the second nodes, the node being included in the second nodes.

15. The system according to claim 9, wherein the processor is configured to:
identify a distance between each of the first nodes and the one or more second nodes when the first processing is assigned to the first nodes of the plurality of nodes, and
determine the third node included in the one or more second nodes, based on a total of the distances identified in correspondence with each of the first nodes.
